(19) United States
(12) Patent Application Publication
(10) Pub. No.: US 2024/0320584 A1
(43) Pub. Date: Sep. 26, 2024

(54) MODULAR SYSTEM FOR FOOD ASSEMBLY

(71) Applicant: Hyphen Technologies, Inc., San Jose, CA (US)

(72) Inventors: Mark Manfrey, El Cerrito, CA (US); Naveen Hattis, Aptos, CA (US); Varun Patel, Cupertino, CA (US); Daniel Fukuba, San Jose, CA (US); Stephen Klein, Santa Monica, CA (US)

(21) Appl. No.: 18/679,243

(22) Filed: May 30, 2024

Related U.S. Application Data
(63) Continuation-in-part of application No. 18/406,656, filed on Jan. 8, 2024.
Application No. 18/406,656 is a continuation of application No. 17/494,736, filed on Oct. 5, 2021.
Application No. 17/494,736 is a continuation of application No. 17/494,743, filed on Oct. 5, 2021.
(60) Provisional application No. 63/469,770, filed on May 30, 2023.
(60) Provisional application No. 63/087,662, filed on Oct. 5, 2020.
(60) Provisional application No. 63/087,662, filed on Oct. 5, 2020.

(51) Int. Cl. G06Q 10/0631; A23L 5/10; A47J 44/00; B65G 37/00; G05B 19/04; H04L 67/12

(52) U.S. Cl. CPC G06Q 10/06316; A23L 5/10; A47J 44/00; B65G 37/005; G05B 19/041; G06Q 10/06311; H04L 67/12; A47J 2201/00

(57) ABSTRACT

One variation a food production system includes: a module housing; a preparation surface arranged above the module housing; a food-dispensing module installed within the module housing and configured to dispense units of an ingredient toward a conveyor module arranged within the module housing; an alert panel integrated within the preparation surface; a set of sensors integrated within the module housing and configured to output timeseries control data representing status of operations at the module housing; and a controller. The controller can: coordinate motion of the conveyor module and selectively trigger the food-dispensing module to dispense the ingredient into a food container, on the conveyor module, to assemble a food product according to a food order; and, in response to interpreting a trigger event based on timeseries control data, trigger the alert panel to output a detectable signal configured to alert an operator of the trigger event at the module housing.

### CROSS-REFERENCE TO RELATED APPLICATIONS

This application claims the benefit of U.S. Provisional Application No. 63/469,770, filed on 30 May 2023, which is incorporated in its entirety by this reference.

This application is also a continuation-in-part of U.S. patent application Ser. No. 18/406,656, filed on 8 Jan. 2024, which is a continuation of U.S. patent application Ser. No. 17/494,736, filed on 5 Oct. 2021, and U.S. patent application Ser. No. 17/494,743, filed on 5 Oct. 2021, which claim the benefit of U.S. Provisional Application No. 63/087,662, filed on 5 Oct. 2020, each of which is incorporated in its entirety by this reference.

### TECHNICAL FIELD

This invention relates generally to the field of food production and more specifically to a new and useful modular system for manual and autonomous food assembly in the field of food production.

### BRIEF DESCRIPTION OF THE FIGURES

FIG. 1 is a schematic representation of a food production station;

FIGS. 2A and 2B are schematic representations of one variation of the food production station;

FIG. 3 is a schematic representation of one variation of the food production station; and

FIG. 4 is a schematic representation of one variation of the food production station.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Food Production Station

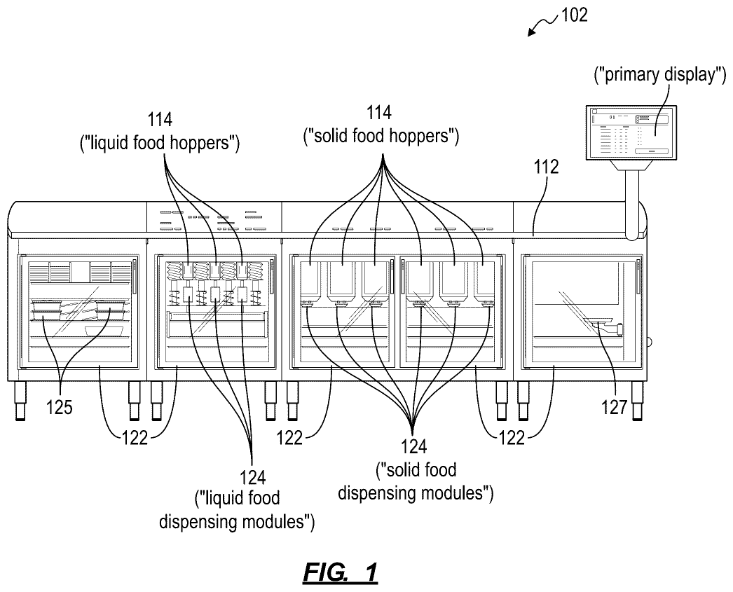

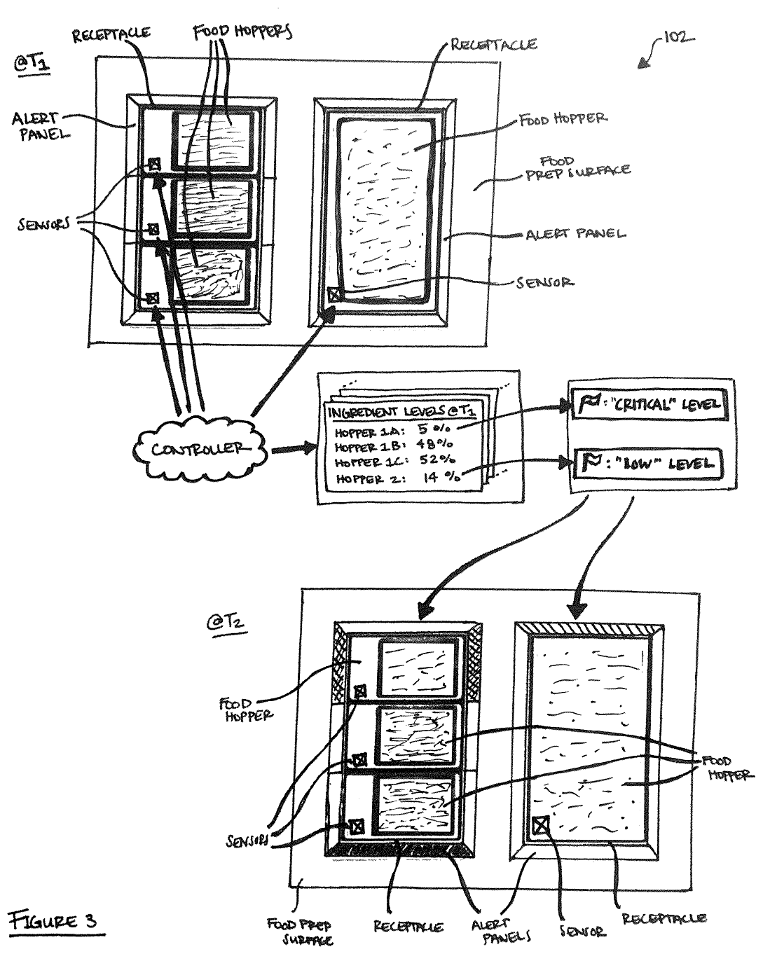

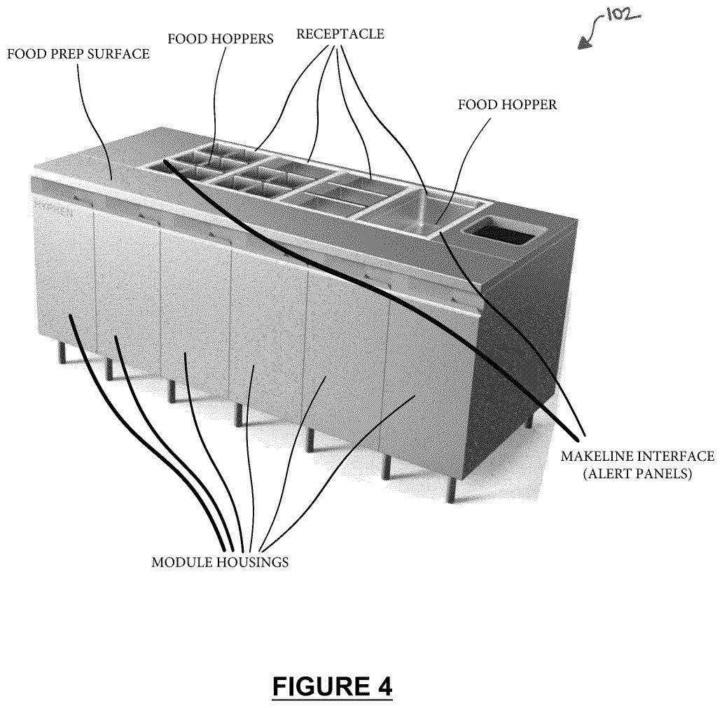

As shown in FIGS. 1, 2A, 2B, 3, and 4, a food production station for assembling units of a food product type includes: a manual assembly zone 110; an autonomous assembly zone 120; a makeline interface; and a controller 140.

The manual assembly zone includes: a food prep surface 112 located at a work surface height and configured for manual preparation of units of the food product type; and a sequence of receptacles configured to receive a sequence of food hoppers 114 configured to store ingredients for manual preparation of a food product type on the food prep surface 112. The autonomous assembly zone 120 includes: a cabinet arranged beneath the food prep surface 112 and including a sequence of module housings 122 supporting the food prep surface 112 and configured to transiently house a sequence of food dispensing modules 124 configured to store and dispense amounts of ingredients for autonomous preparation of units of the food product type; a conveyor module 130—including a set of conveyor units configured to transiently install within the sequence of module housings 122 below the sequence of food dispensing modules 124—configured to transfer a set of food containers along the sequence of food dispensing modules 124 for dispensation of ingredients into the set of food containers; and a set of sensors coupled to the sequence of module housings and configured to capture timeseries control data (e.g., temperature data, weight data, state data) representing status of operations at each module housing in the sequence of module housings.

The makeline interface includes a sequence of alert panels, each alert panel in the sequence of alert panels: coupled to a section of the food prep surface arranged above a particular module housing in the sequence of module housings; and configured to transiently output detectable signals (e.g., a visual, audible, and/or haptic signals) representing status of food assembly operations at the particular module housing; and a global display configured to display information regarding status of the manual assembly zone and autonomous assembly zone. The controller 140 is configured to: receive a set of food orders; coordinate motion of the conveyor 130 and selectively trigger the sequence of food dispensing modules 124 to dispense amounts of ingredients into the set of food containers to assemble units of the food product type according to the set of food orders; interpret a set of trigger events, of a set of trigger types, at each module housing, in the sequence of module housings, based on timeseries control data recorded by the set of sensors; and selectively trigger the sequence of alert panels to output a set of detectable signals configured to alert an operator (e.g., a human operator) of the set of trigger events.

As shown in FIG. 1, one variation of the food production station 102 includes: a container dispensing module 125 configured to dispense containers onto a set of conveyor belts within the conveyor module 130; the conveyor module 130 located adjacent the container dispensing module 125 and configured to transfer the set of food containers along the sequence of food dispensing modules 124 for dispensation of ingredients into the set of food containers; and an elevator module 127 (or “food elevator”) located adjacent the conveyor module 130 and configured to direct the assembled food container toward the food prep surface 112 for collection by a worker and/or presentation to a patron.

### 2. Applications

Generally, the food production station defines a reconfigurable chassis for on-demand food production and includes: a manual assembly zone including a sequence of food hoppers configured to be loaded with ingredients and located along a prep surface supporting manual construction of units of a food product by a worker (e.g., an “employee”); and an automated assembly zone located beneath the prep surface of the manual assembly zone and including a sequence of food dispensing modules configured to transiently (i.e., temporarily) install within a sequence of module housings—transiently installed beneath the food prep surface—of the food production station, configured to store ingredients, and configured to dispense amounts (e.g., masses, volumes, units) of these ingredients to autonomously construct units of a food product. For example, the autonomous assembly zone can be configured to autonomously assemble generic units of the same food type that is manually assembled and customized by the worker at the manual assembly zone. Furthermore, the food production station can be assembled and reconfigured over time to produce various types of food products, such as smoothies, cold bowls (e.g., cold salads), hot bowls (e.g., hot rice bowls), cold sandwiches, hot sandwiches, cold wraps, hot wraps (e.g., burritos), desserts, coffee products, etc.

In one implementation, the controller can be configured to: collect real-time data—recorded by a set of sensors installed throughout the food production station—representing status of various components of the food production station, such as amounts of ingredients contained within the sequence of food hoppers, operation of various modules installed within the food production station (e.g., a conveyor module, a dispenser module), arrangement of modules installed within the food production station, etc.; and leverage this real-time data to identify and flag instances of various trigger events—such as corresponding to a relatively low amount of an ingredient remaining within a food hopper, a jammed or inoperable food-dispensing module, and/or a food spill onto the conveyor module (e.g., outside of a food container)—in (near) real-time. The controller can then selectively activate features of the makeline interface to alert an operator of instances of these trigger events.

In particular, in this implementation, the makeline interface can include a sequence of alert panels, each alert panel, in the sequence of alert panels, coupled to the food prep surface proximal a particular food dispensing module in the sequence of food dispensing modules. The controller can be configured to selectively activate features (e.g., an LED light, an electronic display, an audio speaker) of a particular alert panel, in the sequence of alert panels, to rapidly direct the operator to a particular component of the food production station associated with the instance of the trigger event. For example, in response to predicting an instance of “critical ingredient level” event at a first food hopper corresponding to a first module housing, the controller can trigger a first alert panel—arranged at the food prep surface about the first food hopper—to activate a set of flashing red lights. Additionally, in response to predicting an instance of a “food spill” event within a second module housing, approximately concurrent the “critical ingredient level” event, the controller can trigger a second alert panel—arranged at the food prep surface about a second food hopper corresponding to the second module housing—to activate a solid blue light configured to indicate instances of the “food spill” event. The operator's attention may thus immediately be drawn to the set of flashing red lights, and the operator may quickly interpret this signal and rapidly initiate refilling of this ingredient in the first food hopper. Then, upon deactivation of the set of flashing red lights, the operator's attention may be drawn to the solid blue light, and the operator may investigate an interior of the second module housing to locate the food spill and clean a surface of the second module housing accordingly. Additionally or alternatively, in another example, in response to concurrently predicting the instance of the “critical ingredient level” event at the first food hopper and the instance of the “food spill” event at the second module housing, the controller can: trigger the first alert panel to activate a first signal (e.g., a red light, a blue light, a flashing red light, a text alert, an audible alert) configured to indicate a “critical ingredient level” to the operator and draw the operator's attention to the first food hopper; and—in response to receiving confirmation of replenishment of an ingredient within the first food hopper—trigger the second alert panel to activate a second signal configured to indicate a “food spill” to the operator to draw the operator's attention to the food spill after refilling the ingredient in the first food hopper.

The controller can therefore be configured to: selectively activate features of the makeline interface to rapidly alert the operator of an instance of a trigger event and direct the operator to a source of the trigger event for immediate resolution; and selectively escalate alerts related to high-priority trigger events in order to prioritize resolution of these trigger events by the operator. Therefore, by including this real-time, interactive makeline interface—including a sequence of alert panels distributed across the food production station—the food production station can: reduce downtime due to adverse trigger events (e.g., empty food hoppers, food spills, jammed food-dispensing modules) and therefore increase throughput of the food production station; reduce resources dedicated by the operator toward identifying instances of trigger events and therefore increase resources dedicated by the operator toward manual food assembly, ingredient preparation, and/or maintenance of the food production station.

### 2.1 Sensors

The food production station can include a set of sensors installed within the autonomous assembly zone and/or manual assembly zone. Generally, the set of sensors can be configured to capture real-time control data-such as temperature data (e.g., ingredient and/or interior housing temperature), ingredient amount data (e.g., ingredient weight or depth), state data (e.g., “on” or “off”, “open” or “closed”), etc.—representing current control conditions along the sequence of module housings and/or across the food prep surface of the food production station.

In one implementation, the food production station can include a set of ingredient-level sensors arranged proximal food hoppers, in the sequence of food hoppers, and configured to capture timeseries amounts of ingredients remaining within these food hoppers. For example, the food production station can include a set of load cells, each load cell, in the set of load cells, coupled to a particular food hopper, in the sequence of food hoppers, and configured to capture timeseries weights of a particular ingredient loaded in the particular food hopper. In another example, the food production station can include a set of optical sensors, each optical sensor, in the set of optical sensors, defining a field of view facing an interior volume of a particular food hopper—loaded with a particular ingredient—and configured to record timeseries fill-levels of the particular ingredient loaded within the particular food hopper.

Additionally, in another implementation, the food production station can include a set of temperature sensors coupled to the sequence of food hoppers and configured to capture timeseries temperature data for ingredients loaded in the sequence of food hoppers. For example, the set of temperature sensors can include a first temperature sensor: coupled to a first food hopper, in the sequence of food hoppers, containing units of a first ingredient; and configured to periodically (e.g., once per minute, once per five-minute interval, once per ten-minute interval) record a temperature (e.g., an air temperature, a surface temperature) of the first food hopper, such as a temperature at a bottom, top, and/or center of the first food hopper or at a coldest region of the first food hopper. Additionally, the set of temperature sensors can further include: a second temperature sensor coupled to a second food hopper; a third temperature sensor coupled to a third food hopper; etc. The set of temperature sensors can therefore cooperate to record temperature data for each ingredient stored within a food hopper, in the sequence of food hoppers, arranged within the food production station.

Additionally, in another implementation, the food production station can include a set of “state” sensors configured to capture data representing operating states of various components of the food production station. For example, the food production station can include a contact sensor arranged on a door of a module housing, in the sequence of module housings, and configured to capture data representing a current state of the door, such as “open” or “closed.” In another example, the food production station can include a motion sensor arranged proximal the conveyor module and configured to capture data representing a current state of the conveyor module, such as “mobile” or “immobile.”

Additionally, in yet another implementation, the food production station can include a set of sensors configured to capture data representing identity and/or types of equipment—such as food hoppers, heating and/or cooling units, food containers, etc.—installed within the food production station. For example, the food production station can include a set of optical sensors (e.g., a scanning device) arranged within the receptacle and configured to record identifiers-such as a barcode or QR code-arranged on food hoppers loaded into the receptacle. In particular, the set of optical sensors can include a first optical sensor (e.g., a scanning device) arranged within a first module housing and facing the receptacle. During a setup period, an operator may load a first food hopper—including a QR code affixed to an outer surface of the first food hopper—into the first module housing to seat within the receptacle, such that QR code seats within a field of view of the first optical sensor. The first optical sensor can then record a first image of the QR code to link the first food hopper to the first module housing. Additionally, the set of optical sensors can further include: a second optical sensor arranged within a second module housing; a third optical sensor arranged within a third module housing; etc. The set of optical sensors can therefore cooperate to record data representing an arrangement of food hoppers across the sequence of module housings of the food production station.

### 3. Food Production Station

The modular system 100 can include a food production station 102 configured to install within a food service establishment (e.g., a “fast-casual” restaurant, a ghost kitchen, a food court, a cafeteria) and that can be assembled and reconfigured over time to produce various types of food product, such as smoothies, cold bowls (e.g., cold salads), hot bowls (e.g., hot rice bowls), cold sandwiches, hot sandwiches, cold wraps, hot wraps (e.g., burritos), pizzas, desserts, coffee products, etc.

Once a combination of food dispensing modules 124 are assembled onto the food production station 102 to construct a particular type of food product, the food production station 102 can be loaded with a control program configured to: intake food orders from patrons; and to selectively actuate the food dispensing modules 124 to construct instances of this food product according to these food orders.

The food production station 102 defines a base platform or “chassis” configured to support and locate a combination of food dispensing modules 124 for fulfillment of food orders. In one implementation, the food production station 102 includes: a chassis (e.g., a rigid platform) defining a food prep surface 112; and a cabinet—including a sequence of module housings—arranged beneath the food prep surface 112 and configured to house a sequence of food dispensing modules 124 for fulfillment of food orders; and a sequence of food containers (or “food hoppers”)—transiently arranged within the sequence of module housings—configured to store ingredients for manual preparation of a food product type on the food prep surface. For example, the food production station 102 can include: a steel box frame configured to support a sequence of food hoppers 114 and food dispensing modules 124; a food prep surface 112 (e.g., a stainless steel surface) arranged over a top face of the steel box frame; and a set of legs (e.g., a set of round tubular legs) coupled to a bottom face opposite the top face of the steel box frame and configured to support the steel box frame.

The food production station 102 can include a sequence of food hoppers 114 arranged along a back side of the food prep surface 112 (e.g., opposite an employee working at the food production station 102) such that these food hoppers are arranged contiguously along a length of the food prep surface 112 and ordered accordingly in order to efficiently and satisfactorily complete food orders. The food production station 102 can also include a cabinet: located beneath the food prep surface 112 and within the steel box frame; including a sequence of module housings 122 configured to transiently house a sequence of food dispensing modules 124 configured to selectively dispense food ingredients according to food orders received by the food production station 102.

The food production station 102 can define a particular height (e.g., a work height) such that an employee may comfortably stand facing a front side of the food production station 102 while handling food (e.g., adding ingredients to a serving container, preparing ingredients, refilling food hoppers) on the food prep surface 112 and/or interfacing with a patron. For example, the food production station 102 can exhibit a height—between a ground surface and the food prep surface 112—approximately (e.g., within two inches) between 35 inches and 42 inches. Furthermore, the bottom surface of the food production station 102 can be offset a ground surface (e.g., the floor) in order to enable cleaning beneath the food production station 102. For example, the food production station 102 can include the set of legs defining a particular height such that: an employee may clean the bottom surface of the food production station 102 and surfaces (e.g., the floor) below the food production station 102; the food prep surface 112 sits within a working height range (e.g., between 36 and 38 inches); and the cabinet, including a sequence of food dispensing modules 124, fits between the bottom surface and the food prep surface 112.

### 3.1 Manual Assembly Zone

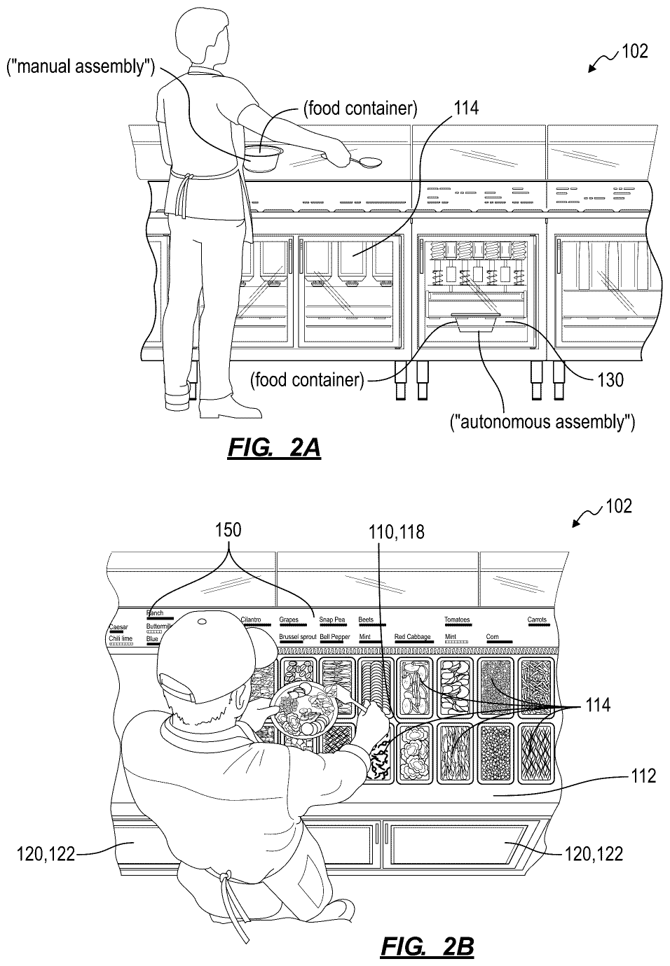

The food production station 102 can include a manual assembly zone 110 including the food prep surface 112 and a receptacle configured to receive the sequence of food hoppers 114 transiently located atop the food prep surface 112 and configured to store ingredients for manual preparation of units of food products according to food orders submitted by patrons. As shown in FIGS. 2A and 2B, the manual assembly zone 110 can be configured such that an employee may stand facing a front side of the food production station 102—proximal the sequence of food hoppers 114—to handle ingredients and/or assemble food orders while a patron views and/or points at ingredients along a back side of the food production station 102.

### 3.2 Autonomous Assembly Zone

The food production station 102 can include an autonomous assembly zone 120 located below the food prep surface 112 of the manual assembly zone 110. The autonomous assembly zone 120 includes: a sequence of module housings 122 configured to house a set of food-handling modules (e.g., food dispensing modules 124, food processing modules); a conveyor configured to move a food container along a length of the autonomous assembly zone 120 as the food container is filled with ingredients; and a controller 140 configured to receive food orders from patrons and selectively actuate the set of food-handling modules for dispensation of ingredients in order to complete these food orders. The autonomous assembly zone 120 can include a sequence of food hoppers 114 configured to store ingredients corresponding to food orders. In one implementation, as described above, the sequence of food hoppers 114 located along the manual assembly zone 110 are coupled to the set of food-handling modules of the autonomous assembly zone 120, such that the sequence of food hoppers 114 can be configured to store ingredients for both the manual assembly zone 110 and the autonomous assembly zone 120.

### 3.2.1 Module Housings

The autonomous assembly zone 120 can include a sequence of module housings configured to transiently locate a and food processing modules along a food-handling side of the autonomous assembly zone 120, such as a first long side of the autonomous assembly zone 120. In one implementation, the autonomous assembly zone 120 defines module housings of a fixed unit dimension and configured to transiently receive food dispensing and processing modules defining a standard footprint. In this implementation, individual food dispensing and processing modules can be loaded into individual module housings along the food-handling side of the autonomous assembly zone 120 to form an assemblage of modules that cooperate to dispense a particular combination of ingredients and to construct these ingredients into a food product of a particular type.

More specifically, the autonomous assembly zone 120 can include a sequence of module housings defining a first sequence of module housings configured to dispense liquids and a second sequence of module housings configured to dispense solid ingredients. For example, in this implementation, individual beverage dispensing modules can be loaded into a first module housing along the food-handling side of the autonomous assembly zone 120, individual food dispensing modules can be loaded into a second module housing along the food-handling side of the autonomous assembly zone 120, and individual processing modules can be loaded into a third module housing along the food-handling side of the autonomous assembly zone 120. Then, upon receiving an order for a particular smoothie, the system can: dispense a first volume of juice into a blender located below a first dispenser at the first module housing; dispense a second volume of frozen fruit into the blender now located below a second dispenser at the second module housing; and locate the blender at the third module housing for blending of the ingredients to make the smoothie.

Alternatively, the autonomous assembly zone 120 can define a continuous module rack or otherwise unabridged slots for food-handling modules along the first side of the autonomous assembly zone 120. For example, the autonomous assembly zone 120 can include a single continuous rail or a set of continuous, parallel rails extending along the food-handling side of the autonomous assembly zone 120 parallel to the anteroposterior axis of the autonomous assembly zone 120. In this example, a food dispensing or processing module can be loaded onto the rail(s), shifted longitudinally to a desired longitudinal position, and then locked onto the linear rack, such as with a threaded fastener or with a clamp.

However, the autonomous assembly zone 120 can include or define delineated module housings or a continuous food-handling rack in any other form and can interface with food dispensing and processing modules in any other way.

### 3.2.2 Conveyer

The food production station 102 can further include a conveyor module configured to install along the autonomous assembly zone 120 and to move a container or other packaging along a sequence of food dispensing and processing modules as the container or packaging is filled with ingredients and processes (e.g., blended, mixed, heated) according to a food order received from a patron. For example, the autonomous assembly zone 120 can include a conveyer module including a continuous belted conveyor, a small-scale automated pallet system, a guided linear actuator, or a timing screw.

The food production station 102 can be configured to prepare multiple food orders simultaneously. In this implementation, the conveyor can be configured to transport multiple containers or other packaging along the sequence of the food dispensing and processing modules concurrently such that the food production station 102 can output a continuous stream of food orders. For example, at a first time, the conveyor can receive a first food container at an initial position along the conveyer. Then, at approximately a second time, the conveyor can: move the first food container from the initial position to a first position at a first food dispensing module; and receive a second food container at the initial position. At approximately a third time, the conveyor can: move the first food container from the first position to a second position at a second food dispensing module; move the second food container from the initial position to the first position; and receive a third food container at the initial position. Therefore, the food production station 102 can begin assembly of additional food orders in the food order queue before completing previous food orders in the food order queue, thus maximizing throughput of food order completion.

In one variation, the conveyor can be segmented such that the conveyor can move different food orders non-linearly (e.g., at different rates, to different food dispensing modules) within the food production station 102. For example, the conveyor can include: a first segment extending between a first food dispensing module and a second food dispensing module; and a second segment extending between the second food dispensing module and a third food dispensing module. In this example, the conveyor can actuate the first segment to move a first food container from the first food dispensing module to the second food dispensing module. As the first food container is filled with a first ingredient in the first food dispensing module, the conveyor can again actuate the first segment to move a second food container from the first food dispensing module toward the second food dispensing module. If, however, the second food container corresponds to a food order not including the first ingredient, the conveyor can actuate the second segment to move the second food container past the second food dispensing module and towards a third food dispensing module. Therefore, the conveyor can continue to move the second food container past the first food container for filling with other ingredients and/or completion of the food order, rather than wait for the first food container at the second food dispensing module.

In another variation, the conveyor can be configured to rotate an orientation (e.g., radial orientation) of food containers or other food order packaging relative the food dispensing modules in order to achieve a particular presentation of ingredients within these containers. For example, the conveyor can be configured to rotate a salad bowl radially (e.g., 360 degrees) while ingredients are dispensed from each food dispensing module, such that the salad bowl exhibits an approximately even distribution (e.g., radial distribution) of ingredients. In another example, the conveyor can be configured to rotate an acai bowl between food dispensing modules, such that different ingredients are located in different regions of the acai bowl. In yet another example, the conveyor can be configured to shift a food container laterally (e.g., perpendicular a dispense path of ingredients dispensed into the food container). Alternatively, in another example, a food ejector (e.g., food dispensing chute) of a food dispensing module can be configured to move positions in order to dispense an ingredient into a particular region of the food container.

### 3.2.3 Food Dispensing Modules

The food production station 102 also includes: a sequence of food dispensing modules, each food dispensing module configured to transiently install on the autonomous assembly zone 120 proximal the conveyor and configured to dispense an amount (e.g., a volume, a mass, a number of units) of an ingredient toward the conveyor; and a set of food processing modules, each configured to transiently install on the autonomous assembly zone 120 proximal the conveyor and configured to modify ingredients dispensed from food dispensing modules onto the conveyor. Generally, the food production station 102 includes a population of food dispensing modules and food processing modules configured to: dispense and modify ingredients, respectively, responsive to control inputs received from controllers in the autonomous assembly zone 120; and to then be removed from the food production station 102 for cleaning and reloading with ingredients before deployment. For example, a worker may rapidly and easily remove (e.g., without any tools) a food dispensing module from the food production station 102 for cleaning, reload the food dispensing module with a particular ingredient, and replace the food dispensing module within the food production station 102.

In one implementation, the autonomous assembly zone 120 includes liquid dispensing modules configured to dispense metered volumes of liquid, such as juice, water, and low-viscosity (or “thin”) sauces. In a similar implementation, the autonomous assembly zone 120 includes food paste dispensing modules configured to dispense metered volumes of gels and higher-viscosity liquids, such as butters, yogurt, and thick sauces (e.g., dressings). In these implementations, a liquid or food paste dispensing module can also include an in-line chiller configured to cool dispensed liquid, such as: one integrated in-line chiller per liquid or food paste dispensing module; or one integrated in-line chiller shared between a group of liquid and/or food paste dispensing modules. Similarly, a liquid or food paste dispensing module can also include an in-line heater configured to heat dispensed liquid (e.g., sauces, soups).

In another implementation, the autonomous assembly zone 120 includes: frozen-food dispensing modules configured to dispense metered volumes or mass units of ice, frozen fruits, and frozen vegetables; refrigerated-food dispensing modules configured to dispense metered volumes or mass units of fresh ingredients (e.g., fruits, vegetables, meats, dairy products); warm-food dispensing modules configured to dispense metered volumes or mass units of warm prepared ingredients (e.g., vegetables, meats, rice, noodles); and dry-food dispensing modules configured to dispense metered volumes or mass unites of ambient temperature ingredients (e.g., granola, nuts, seeds, dried fruit).

In yet another implementation, the autonomous assembly zone 120 includes slicing-type dispensing modules configured: to be loaded with whole (or nearly-whole) units of ingredients, such as lettuce, onion, tomato, kiwi, or apple; to slice stored ingredients when triggered by controllers; and to dispense ingredient slices.

In another implementation, the autonomous assembly zone 120 includes powder food dispensing modules configured to dispense metered volumes or mass units of powdered goods, such as salt, sugar, spices, or seeds.

The autonomous assembly zone 120 can include any combination of these types of food dispensing modules. In one variation, the autonomous assembly zone 120 includes multiple sets of food dispensing modules. For example, the autonomous assembly zone 120 can include: a first set of food dispensing modules configured to dispense metered volumes of different flavored yogurts; a second set of food dispensing modules configured to dispense metered volumes of frozen fruits; and a third set of food dispensing modules configured to dispense different liquid bases (e.g., coffee, orange juice, milk). In response to receiving an order for a particular smoothie, the system can dispense: a first volume of vanilla yogurt; a second volume of frozen pineapple; and a third volume of orange juice.

However, the autonomous assembly zone 120 can include food dispensing modules configured to dispense or meter ingredients of any other type or format.

### 3.2.4 Food Hoppers

In one variation, the sequence of food hoppers of the manual assembly zone 110 and the food dispensing modules of the autonomous assembly zone 120 are physically coextensive, such that the sequence of food hoppers supply ingredients to both the manual assembly zone 110 and the autonomous assembly zone 120.

For example, the food production station 102 can include a reservoir (i.e., a food hopper) extending from the prep surface of the manual assembly zone 110 into the autonomous assembly zone 120 and coupled to an automatic dispenser (i.e., a food dispensing module). When filled with an ingredient, the reservoir can feed the automatic dispenser to automatically complete food orders via the autonomous assembly zone 120. Further, a worker may reach into the reservoir (e.g., from an opening approximately flush the prep surface) to access the ingredient for completion of food orders via the manual assembly 110. The reservoir can include a guard configured to prevent human injury (e.g., due to contact with the automatic dispenser). Alternatively, in the foregoing example, the reservoir can include an automatic divider configured to divide the reservoir into an upper side (or “manual side”) and a lower side (or “automatic side”). The reservoir can include a scale or depth sensor configured to monitor a fill level of an ingredient in the reservoir in both the manual side and the lower side. The controller can then shift this automatic divider to adjust the load of either side of the reservoir (e.g., by oscillating the automatic divider to drop ingredients from the manual side into the automatic side).

Alternatively, the sequence of food hoppers of the manual assembly zone 110 can be configured to supply ingredients only to the manual acclimation zone 110 and the sequence of food dispensing modules of the autonomous assembly zone 120 can be configured to supply and dispense ingredients only to the autonomous assembly zone 110. For example, each food dispensing module can include: an automatic food hopper configured to house a particular ingredient; and an automatic dispenser coupled to the automatic food hopper configured to automatically dispense a quantity (e.g., volume, mass, unit) of the particular ingredient contained in the automatic food hopper.

### 3.3 Controller/Wireless Communication Module

The food production station 102 can include a controller configured to intake food orders from patrons and to selectively actuate the food processing and dispensing modules to construct instances of a food product according to these food orders. More specifically, the autonomous assembly zone 120 can include an integrated controller configured to: receive or access orders submitted by patrons via a user interface (e.g., arranged on a customer-facing façade of the food production station 102, arranged within a food establishment (e.g., a ghost kitchen), or within a native food ordering application executing on user's mobile computing device) and/or via direct interaction with an employee; and handle autonomous fulfillment of these orders by triggering actuation of food dispensing and processing modules 140 in the food production station 102, such as via the database described above.

The autonomous assembly zone 120 can also include a wireless communication module coupled to the controller and configured to: receive food orders for patrons; communicate errors, order fulfillment data, and/or fill status of food dispensing modules in the food production station 102 to a remote computer system; and receive control-related updates executable by the controller when processing food orders.

Alternatively, the controller and wireless communication module (and/or other controls—and communications-related subsystems) can be arranged in a controls module configured to transiently install in a food production station 102.

In one variation, food dispensing modules include a sub-controller configured to locally control dispensation of metered volumes of an ingredient contained in this food dispensing module-such as by implementing closed-loop controls to drive actuators in the food dispensing module based on outputs of various sensors integrated into the food dispensing module-responsive to receipt of a command from the controller to dispense this amount of the ingredient.

### 4. Makeline Interface

The food production station can include an interface configured to display and/or communicate information regarding status of ingredients, components of the food production station (e.g., food-dispensing modules, conveyor module, container module, module housings), and/or food orders to operators (e.g., human operators) handling, preparing, and/or serving food at the food production station. For example, the food production station can include: a primary display—such as a monitor—arranged on an end of the food prep surface and configured to display a next set of food orders in a food order queue, a list of high-priority tasks for completion by the operator, and/or a list of each ingredient requiring a refill within a particular time period; and a set of alert panels, each alert panel, in the set of alert panels, integrated into a particular module housing, in the sequence of module housings, and configured to alert the operator of various events—such as instances of food preparation errors, low levels of ingredients, and/or hardware malfunctioning-corresponding to the particular module housing. In this example, the food production station can therefore include a global display (i.e., the primary display)—configured to communicate relatively low-resolution information to an operator or group of operators regarding status of the food production station—in combination with local displays (i.e., the set of alert panels) arranged on the sequence of food module housings and configured to communicate relatively high-resolution information to the operator regarding status of ingredients, food orders, and/or hardware operation at this particular food-module housing.

In one implementation, the food production includes: a primary display (i.e., a digital interface) arranged on the food prep surface and/or coupled to the food production station; and a set of alert panels integrated into the sequence of module housings. The primary display can be configured to: render global information related to status of ingredients, hardware components, and/or food orders within the food production station; and/or receive inputs from an operator of the food production station, such that the operator may provide feedback to the controller and/or manually regulate operation of the makeline interface and/or other components of the food production station.

### 4.1 Local: Alert Panel

The food production station can include a set of alert panels coupled to the sequence of module housings and configured to alert an operator of a particular event at or within a particular module housing in the sequence of module housings. Each alert panel can be configured to transiently output signals (e.g., visual, haptic, text, and/or audio signals) representative of current status of components associated with the particular module housing.

For example, each alert panel can include: an array of lights configured to output visual signals of various colors; a digital display configured to render text, images and/or icons configured to receive user inputs; a speaker configured to output audible signals; and/or a vibrational device configured to output haptic feedback. In particular, in one example, the food production station can include an alert panel including an array of LED lights arranged about a hopper receptacle-integrated into the food prep surface and extending into a module housing installed beneath the food prep surface—and approximately flush the food prep surface. In this example, the alert panel can be configured to: transiently activate a set of blue lights, in the array of LED lights, to signal instances of a “food spill” event; transiently activate a set of red lights to signal instances of an “ingredient refill” event; and transiently activate a set of pulsing red lights to signal instances of a “dispenser error” event; etc.

In one implementation, the food production station can include a set of alert panels coupled to the food prep surface, each alert panel, in the set of alert panels, integrated into a particular receptacle—corresponding to a particular module housing—of the food prep surface. In particular, each alert panel, in the set of alert panels, can be transiently and/or semi-permanently installed within a receptacle, in the sequence of receptacles, and configured to alert the operator of trigger events—such as a “dispenser error” event, an “ingredient refill” event, a “food spill” event—associated with a corresponding module housing. For example, the food prep surface can define a first section defining a first receptacle configured to transiently receive a first food hopper. The sequence of module housings can include a first module housing—arranged beneath the first section-including a first food dispensing module arranged below the first receptacle and configured to transiently couple to the first food hopper. In particular, a user may seat the first food hopper within the first receptacle—such that an upper rim of the first food hopper seats approximately flush the food prep surface—to engage features of the first food dispensing module and couple the first food hopper to the first food dispensing module. In this example, the food production station can further include a first alert panel arranged within and about a perimeter of the first receptacle. The first alert panel can: define an upper face configured to seat approximately flush the food prep surface; and include a set of alert features—such as an array of lights, an audio device (e.g., a speaker), and/or a digital display—arranged on the upper face and configured to transiently output a set of detectable signals responsive to a set of trigger events detected at the first module housing.

In the preceding implementation, in order to enable installation of food hoppers within the sequence of receptacles (e.g., by an operator), each alert panel can be configured to nest within a particular receptacle and define a center bore—coextensive the particular receptacle—configured to transiently receive a food hopper to seat the food hopper within a corresponding receptacle. For example, a first alert panel, in the set of alert panels, can include: a set of four walls, each wall, in the set of four walls, configured to mate with a corresponding wall of the first receptacle; and a set of coupling features configured to rigidly couple the first alert panel to the food prep surface within the first receptacle. The set of four walls can cooperate to: define an upper face arranged approximately flush the food prep surface; and define a center bore—coaxial the first receptacle—configured to transiently receive a first food hopper to seat the first food hopper within the first receptacle in a loaded configuration, an upper rim of the first food hopper approximately flush the upper face and the food prep surface in the loaded configuration.

Additionally and/or alternatively, in another implementation, the food production station can include a set of alert panels arranged along an edge of the food prep surface. In particular, in this implementation, each food module housing, in the sequence of food module housings, can include an alert panel integrated into the food prep surface and extending along an edge of the food prep surface, such as along the operator side of the food production station.

Additionally or alternatively, in another implementation, each module housing, in the sequence of module housings, can include an alert panel affixed to the module housing—such as arranged on a door of the module housing arranged on the operator side of the food production station, arranged on the food prep surface on a customer-facing side opposite the operator side of the food production station, and/or arranged within an interior of the module housing—and configured to render: information related to status of ingredients (e.g., temperature, ingredient level, ingredient duration), hardware components, and/or food orders within this particular module housing; and/or receive inputs from an operator, such that the operator may provide feedback to the controller and/or manually regulate operation of the makeline interface and/or other components of the food production station.

In one example, a module housing can include: a first alert panel integrated into the receptacle, as described above, and including a first set of alert features (e.g., LED lights) configured to indicate level of ingredients in food hoppers installed within the receptacle; a second alert panel integrated into and extending along an edge of the food prep surface—proximal the operator side—including a second set of alert features (e.g., an LED display) configured to indicate instances of error events (e.g., low ingredient levels, jammed dispenser, improper temperature regulation) within the module housing; and a third alert panel—defining a digital display—configured to receive user inputs related to operation (e.g., temperature control, activation and/or deactivation of the food-dispensing module) of components within the module housing and/or render high-er resolution information associated with error events indicated by the second alert panel. The first alert panel, the second alert panel, and the third alert panel, can therefore cooperator to provide the operator with both low-resolution and high-resolution information related to status of ingredients, components, and/or food assembly within this particular module housing.

### 4.1.1 Interactive Features

In one implementation, the food production station can include a set of alert panels configured to render a set of selectable icons configured to receive user inputs from an operator of the food production station.

For example, a first alert panel—integrated into a first module housing—can include a digital display configured to render a set of selectable icons including a first icon configured to receive a first user input indicating confirmation to “reactivate” or resume operation of components within the first module housing. In this example, in response to selection of the first user input by the operator, the controller can: receive confirmation to reactivate operation of components—including the food-dispensing module and/or the conveyor module—within the first module housing; and automatically trigger actuation of these components according to a particular food order. In this example, by enabling the operator to confirm reactivation of these components prior to resuming operations, the food production station can reduce risk of injury to the operator and/or damage to these components due to premature reactivation of these components.

In the preceding example, the set of selectable icons can additionally include: a second icon configured to receive a second user input indicating confirmation to “deactivate” or pause operation of components within the first module housing; a third icon configured to receive a third user input indicating execution of an action by the operator—such as refilling an ingredient, cleaning an interior and/or exterior of the first module housing, removing a food container from the conveyor module within the first module housing, etc.—at the first module housing; etc.

### 4.2 Local: Secondary Alert Features

In one variation, the food production station can further include a set of secondary alert features integrated within the sequence of module housings and configured to signal instances of pre-defined trigger events within a particular module housing. In particular, in this variation, the set of secondary alert features can be configured to provide relatively high-resolution information to the operator regarding status of various components of the particular module housing by directing the operator to a particular component (e.g., the dispenser module, the conveyor module, a jammed container, an empty or low-level food hopper) associated with a trigger event. For example, a first module housing can include: a first light feature arranged adjacent and facing the conveyor module; a second light feature arranged adjacent and facing the food dispensing module; a third light feature arranged on a wall of the first module housing and configured to face a food hopper transiently loaded within the receptacle; and a fourth light feature arranged on a door of the first module housing. In this example, a controller can therefore: transiently activate the first light feature responsive to an event associated with the conveyor module; transiently activate the second light feature responsive to an event associated with the food dispensing module; transiently activate the third light feature responsive to an event associated with the food hopper; and/or transiently activate the fourth light feature responsive to an event associated with the door of the first module housing.

In this variation, the set of alert panels can be configured to signal instances of trigger events at or within module housings of the food production station. The set of secondary alert features can then be configured to more precisely signal a particular source and/or type of event within a particular module housing. For example, a first module housing-transiently installed beneath a first section of the food prep surface —can include a first set of secondary alert features including: a first light feature arranged adjacent and facing the conveyor module; and a second light feature arranged adjacent and facing the food dispensing module. The first section of the food prep surface can define a first receptacle—extending below the food prep surface into the first module housing—and include a first alert panel arranged radially about the first receptacle. In this example, the first and second light feature can be configured to cooperate with the first alert panel to: alert an operator of a particular event associated with the conveyor module and/or food dispensing module within the first module housing; and/or trigger the operator to execute a particular action responsive to the particular event. In particular, in response to a “spill” event-corresponding to spilled food on the conveyor module—the controller can: trigger activation of a set of lights on the first alert panel; and trigger activation of the first light feature within the first module housing. The operator may therefore: immediately approach the first module housing responsive to activation of the set of lights on the first alert panel; and open a door of the first module housing to investigate an interior of the first module housing. Then, in response confirming activation of the first light feature—rather than the second light feature—the operator may immediately associate the first light feature with the conveyor module and thus rapidly locate and remove (e.g., by cleaning a surface of the conveyor module) spilled food from a surface of the conveyor module.

### 4.3 Global: Primary Display

Additionally, the food production station can include a primary display arranged on the food prep surface. In one implementation, the primary display can be configured to display information regarding status of ingredients and/or food orders to employees who are handling, preparing, and/or serving food. For example, the food production station can include a monitor located on the food prep surface of the manual assembly zone and configured to display a prioritized list of ingredients needing replacement, such as based on a quantity of these ingredients remaining and/or ingredients needed to complete queued food orders (e.g., food orders received and not yet completed).

Additionally or alternatively, in another implementation, the primary display (e.g., a touch-screen interface) can be configured to render a set of control icons—selectable by an operator—configured to receive inputs from the operator and selectively trigger the makeline interface to output a set of signals corresponding to the operator selection. In particular, each control icon, in the set of control icons, can correspond to a particular mode, in a set of modes, defined for the makeline interface. Therefore, in response to selection of a first control icon, in the set of control icons, by the operator, the controller can selectively trigger the makeline interface—including the primary display, the set of alert panels, and/or the set of secondary features—to output a set of signals according to a first mode, in the set of modes, linked to the first control icon.

For example, the primary interface can render a set of control icons including: a first control icon corresponding to a diagnostic mode defining a first set of signals indicating a lifespan of components within the food production station; a second control icon corresponding to an ingredient replenishment mode defining a second set of signals indicating a remaining amount of ingredients loaded within the food production station; and/or a third control icon corresponding to a status mode defining a third set of signals indicating current status—such as including a temperature, an ingredient fill level, any current operating errors, etc.—of components of the food production station. In this example, in response to selection of the first control icon-corresponding to the diagnostic mode—the controller can: access and/or calculate a remaining lifespan of each component-including food dispensing modules, conveyor modules, sensors, food hoppers, heating and/or cooling units, etc.—installed within the food production station; and trigger each alert panel, in the set of alert panels, to display a list of each component installed within the module housing—corresponding to the alert panel—paired with a lifespan of that particular component.

### 5. Control Program: Trigger Events

The food production station can be loaded with a control program configured to selectively trigger the makeline interface to output various signals—detectable by a human operator (e.g., an employee)—responsive to trigger events. More specifically, the control program can be loaded on the controller and thus configured to enable the controller to selectively activate features of the makeline interface to rapidly alert the operator of an instance of a trigger event and direct the operator to a source of the trigger event for immediate resolution.

In particular, in one implementation, the controller can: access timeseries control data recorded by the set of sensors arranged across the manual assembly zone and autonomous assembly zone of the food production station; characterize a current status of each component—including the sequence of module housings, the sequence of food hoppers, the sequence of food dispensing modules, the conveyor module, etc.—of the autonomous assembly zone and the manual assembly zone based on timeseries control data. The controller can then leverage the control program to: predict instances of trigger events associated with these components based on the current status; and selectively activate features of the makeline interface—such as at a particular alert panel corresponding to a particular module housing—configured to alert the operator of instances of these trigger events.

For example, the control program can define: a “non-compliant ingredient” event corresponding to units of an ingredient at temperatures below a threshold temperature and/or corresponding to units of an ingredient remaining in a food hopper for a threshold duration; a “low ingredient level” event corresponding to a food hopper containing an amount of an ingredient less than a threshold amount; an “empty ingredient” event corresponding to a food hopper containing insufficient amounts of an ingredient for assembly of a food order; a “dispenser error” event corresponding to malfunctioning of one or more food dispensing modules in the sequence of food dispensing modules; a “conveyor error” event corresponding to malfunctioning of one or more units of the conveyor module; etc. In this example, the control program can further define a set of detectable signals representing each of these trigger events, such as: a first signal—corresponding to activation of a flashing red light on a corresponding alert panel—representing instances of the “non-compliant ingredient” event; a second signal—corresponding to activation of a solid (e.g., constant, non-flashing) yellow light on a corresponding alert panel—representing instances of the “low-ingredient level” event; a third signal—corresponding to activation of a solid red light on a corresponding alert panel—representing instances of the “empty ingredient” event; a fourth signal—corresponding to activation of a pulsing array of lights—on a corresponding alert panel—representing instances of the “dispenser error” event; and/or a fifth signal—corresponding to activation of a pulsing blue light on a corresponding alert panel—representing instances of the “conveyor error” event.

### 5.1 Setup Period

In one implementation, the controller can verify a setup or “makeline configuration” of the food production station—such as during an initial setup period at a start of each day—and selectively activate features of the makeline interface to indicate verification and/or non-compliance of the makeline configuration according to the control program. For example, the controller can confirm an arrangement of the sequence of food hoppers—such as including food hoppers of various sizes (e.g., full-size hoppers, one-third-size hoppers, one-sixth size hoppers) and/or configured to hold ingredients of different types and/or temperatures—within the sequence of receptacles. In this example, the controller can: access a target arrangement defined for the sequence of food hoppers by the control program; verify installation of each food hopper, in the sequence of food hoppers, according to the target arrangement, such as based on scannable identifiers arranged on the sequence of food hoppers; and selectively trigger the set of alert panels—each alert panel corresponding to a particular module housing loaded with a particular food hopper—to output detectable signals indicating verification of the particular food hopper and/or an instance of a “non-compliant setup” event.

In particular, in the preceding example, the food production station can include: a first optical sensor (e.g., a scanning device) arranged within a first module housing—including a first food-dispensing module installed within the first module housing—or arranged within a first receptacle extending into the first module housing; and a first alert panel arranged about the first receptacle. A first food hopper can include a first identifier—such as an RFID or a QR code—arranged on an outer wall of the first food hopper. Then, during a setup period for the food production station, an operator may insert the first food hopper into the first receptacle to couple the first food hopper with the first food-dispensing module. Upon insertion of the first food hopper into the first receptacle, the first optical sensor can be configured to capture an image of the first identifier arranged on the first food hopper. The controller can then: receive this image from the first optical sensor; access a target identifier—corresponding to hoppers of a first hopper type (e.g., hot food, cold food, full-size hopper, one-third-size hopper) assigned to the first receptacle for a subsequent live period—specified by the target arrangement; and characterize a difference between the target identifier and the first identifier. Based on the difference, the controller can selectively: verify the first food hopper as corresponding to the first hopper type and confirm installation of the first hopper in the first slot; or withhold verification of the first food hopper as corresponding to the first hopper type and predict an instance of a non-compliant hopper event. In this example, in response to verifying the first food hopper as the first hopper type, the controller can trigger a first alert panel—arranged about the first receptacle—to output a first signal representing verification of the first food hopper. Alternatively, in response to predicting an instance of the non-compliant hopper event, the controller can trigger the first alert panel to output a second signal corresponding to instances of the non-compliant hopper event.

The controller can therefore immediately notify the operator of the instance of the non-compliant hopper event and direct the operator to the first receptacle containing the first food hopper. The operator may therefore rapidly locate the first food hopper based on the second signal output by the first alert panel and reassemble the sequence of food hoppers accordingly, such as prior to loading of ingredients into food hoppers and/or prior to assembling any food orders.

### 5.2 Live Period

The controller can track status of the food production station-such as functionality of various modules (e.g., the conveyor module, food-dispensing modules), availability of ingredients loaded in the sequence of food hoppers, arrangement and/or types of modules and food hoppers installed within the food production station, a list of food orders in assembly and/or in a food order queue, etc.—to identify instances of trigger events during a live period succeeding the initial setup period. Then, in response to identifying a particular trigger event during the live period, the controller can trigger the makeline interface to output a particular signal configured to alert an operator of the particular trigger event and direct the operator to a source of the trigger event. The controller—loaded with the control program—and the makeline interface can therefore cooperate to: rapidly and clearly communicate an instance of a trigger event to the operator in (near) real-time, such as during processing and assembly of food orders submitted by patrons; and provide sufficient context regarding a type and/or location of the trigger event, within the food production station, to enable the operator to rapidly resolve the instance of the trigger event.

### 5.2.1 Ingredient Replenishment

In one implementation, the controller can: track timeseries amounts of ingredients-recorded by sensors in the set of sensors-remaining in food hoppers, in the sequence of food hoppers, arranged within the food production station; identify instances of trigger events associated with replenishment of ingredients based on timeseries amounts of ingredients; and selectively trigger the makeline interface to output a set of signals responsive to instances of trigger events and configured to inform the operator of ingredients requiring immediate replenishment and/or replenishment within a particular time window. For example, the control program can define: a “passable ingredient level” event as corresponding to instances of an ingredient amount exceeding an upper threshold amount; a “low ingredient level” event as corresponding to instances of an ingredient amount falling below an upper threshold amount; and/or a “critical ingredient level” event as corresponding to instances of an ingredient amount falling below a lower threshold amount. In this implementation, by tracking ingredient levels over time and selectively triggering the operator to refill ingredients, the food production station can be configured to enable increased efficiency in food order preparation, such as by: reducing food waste due to preparation and/or refilling of ingredients at excessive frequencies and/or in excessive quantities that result in unused, prepared ingredients; and minimizing time-spent by an operator preparing and/or refilling ingredients.

In one example, the food production station can include a receptacle, in the sequence of receptacles, loaded with: a first food hopper containing units of a first ingredient; a second food hopper containing units of a second ingredient; and a third food hopper containing units of a third ingredient. The food production station can further include: a module housing—arranged beneath the food prep surface coaxial the receptacle—loaded with a food-dispensing module configured to transiently dispense units of the first, second, and third ingredients from the first, second, and third food hoppers to assemble food orders based on commands received from the controller; and an alert panel arranged about the receptacle at the food prep surface. In particular, the alert panel can include: a first set of alert features arranged adjacent a rim of the first food hopper within the receptacle; a second set of alert features arranged adjacent a rim of the second food hopper within the receptacle; and a third set of alert features arranged adjacent a rim of the third food hopper within the receptacle. The controller can then: access a first weight of the first ingredient recorded at a first time by a first weight sensor (e.g., a load cell) coupled to the first food hopper; interpret a first quantity of servings of the first ingredient remaining within the first food hopper at the first time based on the first weight and known characteristics (e.g., average weight of a single unit) of the first ingredient; access a threshold quantity of servings defined by the control program for the first ingredient, such as defined for a particular day of the week, time of day, ingredient arrangement, etc.; and, in response to the first quantity falling below a lower threshold, interpret a “critical ingredient level” event for the first food hopper and trigger the first set of alert features to output a first signal (e.g., a red light), in a set of signals, defined for instances of the “critical ingredient level” event.

Further, the controller can repeat this process for the second and third ingredients to: access a second weight of the second ingredient recorded at the first time by a second weight sensor coupled to the second food hopper; access a third weight of the third ingredient recorded at the first time by a third weight sensor coupled to the third food hopper; interpret a second quantity of servings of the second ingredient remaining within the second food hopper at the first time based on the second weight and known characteristics of the second ingredient; and interpret a third quantity of servings of the third ingredient remaining within the third food hopper at the first time based on the third weight and known characteristics of the third ingredient. Then, in response to the second quantity of the second ingredient exceeding the lower threshold and falling below an upper threshold, the controller can: interpret a “low ingredient level” event for the second food hopper; and trigger the second set of alert features to output a second signal (e.g., a yellow light), in the set of signals, defined for instances of the “low ingredient level” event. Further, in response to the third quantity of the third ingredient exceeding the upper threshold, the controller can: interpret a “passable ingredient level” event for the third food hopper; and withhold activation of the third set of alert features accordingly.

Additionally, in one implementation, the controller can be configured to selectively group alerts output by the makeline interface-responsive to trigger events associated with amounts of ingredients in the sequence of food hoppers—in order to: enable timely fulfillment of food orders with minimal food waste (i.e., loaded ingredient quantities not dispensed within defined food handing durations); minimize down time for reloading food hoppers and food dispensing modules; and minimize time spent by the operator reloading food hoppers and food dispensing modules. For example, at a first time, the controller can: predict a “low ingredient level” event for a first ingredient; and predict a “moderate ingredient level” event for a second ingredient. Rather than immediately alert the operator of the “low ingredient level” event, the controller can: predict demand for the first ingredient during a particular time window succeeding the first time; estimate a first duration between the first time and a “critical ingredient level” event for the first ingredient based on predicted demand; predict demand for the second ingredient during the particular time window; and estimate a second duration between the first time and a “low ingredient level” event for the second ingredient. Then, in response to the first duration falling below and within a threshold deviation of the second duration, the controller can: withhold alerting the operator of the “low ingredient level” event for the first ingredient at the first time; and, later, at a second time succeeding the first time by approximately the first duration, trigger the makeline interface to output a set of signals configured to alert the operator to refill the first and second ingredient.

### 5.2.2 Food Assembly

In one implementation, the controller-loaded with the control program—can cooperate with the sequence of alert panels to provide feedback to an operator during manual assembly of a food order. In particular, in this implementation, the controller can selectively trigger the sequence of alert panels to highlight ingredients required for assembly of the food order to enable the operator to visually confirm a location of ingredients required for assembling this particular food order as the operator moves the food order down the makeline. For example, a patron may submit a food order specifying a set of ingredients including: rice; lettuce; chicken; salsa; and cheese. Upon selection of this food order by the operator-such as at the primary display—the controller can automatically trigger the sequence of alert panels to output a set of signals—each signal corresponding to a particular ingredient in the set of ingredients-configured to direct the operator toward: a first food hopper containing rice; a second food hopper containing lettuce; a third food hopper containing chicken; a fourth food hopper containing salsa; and a fifth food hopper containing cheese. The operator may therefore approach the food prep surface and rapidly locate each ingredient, in the set of ingredients, based on detection of each signal, in the set of signals, proximal the corresponding food hopper.

Additionally, in the preceding example, the controller can be configured to incrementally deactivate each signal, in the set of signals, as the operator loads a corresponding ingredient into a food container to assemble the food order. In particular, in one example, at a first time during an assembly period for the food order, the controller can: trigger a first alert panel, in the sequence of alert panels, to activate a light feature arranged proximal the first food hopper containing rice; and access a first amount of rice remaining within the first food hopper. During the assembly period, the controller can continue to track a remaining amount of the first ingredient at a target frequency (e.g., once per second, once per ten-second interval). Then, at a second time succeeding the first time during the assembly period, the controller can: access a second amount of rice remaining within the first food hopper; characterize a difference between the first amount of rice and the second amount of rice; and, in response to the difference exceeding a threshold difference (e.g., corresponding to a target serving size), trigger the first alert panel to deactivate the light feature. In this example, the controller can similarly track remaining amounts of each ingredient, in the set of ingredients, throughout the assembly period and selectively deactivate each signal, in the set of signals, accordingly.

### 5.2.3 Food Quality & Safety

In one implementation, the controller-loaded with the control program—can cooperate with the sequence of alert panels to alert the operator of instances of “non-compliant ingredient” events. In particular, in this implementation, the control program can define a set of ingredient rules for each ingredient, in the set of ingredients, configured to maintain a target food quality and a target food safety. In this implementation, the food production system can therefore be configured to enable implementation of practices that both promote food quality (e.g., freshness) and safety while minimize food waste, such as due to preparing and/or loading of excess ingredients.

For example, the control program can define a maximum duration between loading of a particular ingredient into a food hopper and dispensing of the particular ingredient from the food hopper. In this example, the controller can: interpret a first refill event for the particular ingredient based on a change in amount of the particular ingredient, loaded within the food hopper, represented by timeseries amounts of the particular ingredient (e.g., recorded by a sensor installed in the food hopper); and initiate a timer for the maximum duration concurrent the first refill event. Then, in response to expiration of the maximum duration prior to detecting a second refill event, the controller can: interpret an instance of a non-compliant ingredient event for the first ingredient; and trigger an alert panel, in the sequence of alert panels, corresponding to the first food hopper to activate a signal—detectable by the operator—associated with the non-compliant ingredient event. In this example, the control program can further define: a minimum temperature for holding units of a particular ingredient; and/or a maximum temperature for holding units of a particular ingredient. The controller can similarly monitor a temperature of the particular ingredient over time and interpret instances of non-compliant ingredient events accordingly.

### 5.2.4 Module Errors

In one implementation, the controller—loaded with the control program—can cooperate with the sequence of alert panels to alert the operator of instances of “module error” events. In particular, in this implementation, the controller can selectively trigger the sequence of alert panels to notify the operator of component or module failure, such as a malfunctioning food-dispensing module, conveyor module, container-dispensing module, food elevator module, etc.

In one example, the controller can leverage timeseries amounts of ingredients recorded by the set of sensors to detect instances of “dispenser error” events. For example, during autonomous assembly of a food order—specifying a first ingredient loaded within a first food hopper—the controller can: at a first time, access an initial amount of the first ingredient loaded within the first food hopper and trigger a first food-dispensing module—coupled to the first food hopper—to dispense a target amount of the first ingredient into a container; and, at a second time succeeding the first time, access a final amount of the first ingredient loaded within the first food hopper. Then, in response to a difference between the initial amount and the final amount approximating the target amount, the controller can confirm dispensation of the first ingredient into the container. However, in response to the difference falling below the target amount, the controller can interpret an instance of a “dispenser error” event for the first food-dispensing module and immediately trigger a first alert panel—arranged about the first food hopper—to activate a particular signal associated with the “dispenser error” event. The operator may therefore rapidly associate this particular signal with a “dispenser error” event at the first food-dispensing module and repair the first food-dispensing module accordingly.

In another example, during a dispensation period for an ingredient loaded within a food hopper installed within a module housing—the controller can: at a first time, trigger a food-dispensing module, coupled to the food hopper, to dispense a first amount of the ingredient from the food hopper into a food container—arranged below the food-dispensing module on the conveyor module—at a target speed defined for dispensation of the ingredient into the food container; at approximately the first time, initiate a timer for completing dispensation of the ingredient into the food container; and track a dispensed ingredient amount—corresponding to an amount of the ingredient dispensed into the food container—based on a change in mass of the food container captured by a load cell installed within the conveyor module. Then, at a second time, in response to expiration of the timer and the dispensed ingredient amount falling below the first amount, the controller can: trigger the food-dispensing module to dispense a remaining amount of the ingredient into the food container at a reduced speed less than the target speed; and trigger activation of a set of signals on the makeline interface indicating a “dispenser error” at the food-dispensing module, such as including a first alert, at a first resolution, on an LED display integrated into the food prep surface of the module housing, a second alert—at a second resolution exceeding the first resolution—on a digital display coupled to the module housing, and a third alert on the global display; and initiate a second timer for completing dispensation of the ingredient into the food container. Then, in response to the dispensed amount corresponding to the first amount prior to expiration of the second timer, the controller can automatically set the food-dispensing module to operate at the target speed and confirm resolution of the “dispenser error.”

Alternatively, in response to expiration of the second timer and the dispensed ingredient amount falling below the first amount, the controller can automatically deactivate the food-dispensing module and update the set of signals to indicate deactivation of the food-dispensing module and the “dispenser error.” The operator may then: investigate and/or manually resolve the “dispenser error”; and select an icon rendered on the digital display (i.e., an alert panel) configured to trigger reactivation of the food-dispensing module. The controller can then again trigger the food-dispensing module to dispense the ingredient into the food container at the target speed accordingly.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A food production station for assembling units of a food product type comprising:
a manual assembly zone:
defining a food prep surface located at a work surface height and configured for manual preparation of units of the food product type; and
comprising a sequence of receptacles configured to receive a sequence of food hoppers configured to store ingredients for manual preparation of a food product type on the food prep surface;
an autonomous assembly zone comprising;
a cabinet arranged beneath the food prep surface and comprising a sequence of module housings supporting the food prep surface and configured to transiently house a sequence of food dispensing modules configured to store and dispense amounts of ingredients for autonomous preparation of units of the food product type;
a conveyor module:
comprising a set of conveyor units configured to transiently install within the sequence of module housings below the sequence of food dispensing modules; and
configured to transfer a set of food containers along the sequence of food dispensing modules for dispensation of ingredients into the set of food containers; and
a set of sensors coupled to the sequence of module housings and configured to capture timeseries control data representing status of operations at each module housing in the sequence of module housings;
a makeline interface comprising:
a sequence of alert panels, each alert panel in the sequence of alert panels:
coupled to a section of the food prep surface arranged above a particular module housing in the sequence of module housings; and
configured to transiently output detectable signals representing status of food assembly operations at the particular module housing; and
a global display configured to display information regarding status of the manual assembly zone and autonomous assembly zone; and
a controller configured to:
receive a set of food orders;
coordinate motion of the conveyor and selectively trigger the sequence of food dispensing modules to dispense amounts of ingredients into the set of food containers to assemble units of the food product type according to the set of food orders;
interpret a set of trigger events, of a set of trigger types, at each module housing, in the sequence of module housings, based on timeseries control data recorded by the set of sensors; and
selectively trigger the sequence of alert panels to output a set of detectable signals configured to alert an operator of the set of trigger events.

2. The method of claim 1:
further comprising:
a container dispensing module configured to dispense containers onto a set of conveyor belts within the conveyor module; and
an elevator module located adjacent the conveyor module and configured to direct the assembled food container toward the food prep surface for collection by an operator; and
wherein the conveyor module is arranged adjacent the container dispensing module interposed between the container dispensing module and the elevator module.
